(19) United States
(12) Patent Application Publication
(10) Pub. No.: US 2019/0051192 A1
(43) Pub. Date: Feb. 14, 2019

(54) IMPACT AVOIDANCE FOR AN UNMANNED AERIAL VEHICLE

(71) Applicant: Intel IP Corporation, Santa Clara, CA (US)

(72) Inventors: Roman Schick, Krailling (DE); Daniel Pohl, Puchheim (DE)

(21) Appl. No.: 15/813,245

(22) Filed: Nov. 15, 2017

(51) Int. Cl. G08G 5/04; G08G 5/00; G05D 1/04; B64C 39/02

(52) U.S. Cl. CPC G08G 5/045; G08G 5/0069; B64C 2201/028; B64C 39/024; G05D 1/042

(57) ABSTRACT

According to various aspects, an unmanned aerial vehicle may be described, the unmanned aerial vehicle including: one or more sensors configured to receive obstacle information associated with a location of one or more obstacles in a vicinity of the unmanned aerial vehicle; and one or more processors configured to generate movement data associated with a locomotion of the one or more obstacles based on the obstacle information, predict an impact of the one or more obstacles with the unmanned aerial vehicle based on the generated movement data, and control the unmanned aerial vehicle to reduce an altitude to avoid the predicted impact.

### TECHNICAL FIELD

Various aspects relate generally to an unmanned aerial vehicle and a method for operating an unmanned aerial vehicle.

### BACKGROUND

An unmanned aerial vehicle (UAV) may have one or more processors to control flight of the unmanned aerial vehicle along a predefined flight path. The one or more processors to control flight of the unmanned aerial vehicle may be or may include a flight controller. The predefined flight path may be provided and/or modified, for example, by manual remote control, waypoint control, target tracking, etc. Further, an obstacle detection and avoidance system may be implemented to avoid collision of the unmanned aerial vehicle with an obstacle located in the predefined flight path of the unmanned aerial vehicle. As an example, an unmanned aerial vehicle with obstacle detection may be configured to stop in front of a solid object, as for example, a wall, a tree, a pillar, etc., and thus avoiding a collision.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 shows an unmanned aerial vehicle, according to various aspects;

FIG. 2A and FIG. 2B show a collision avoidance operation 200 of an unmanned aerial vehicle, according to some aspects;

FIGS. 3A to 3C show an exemplary use of a map generated based on obstacle information, according to some aspects;

FIGS. 4A to 4E show a collision avoidance operation and an impact avoidance operation based on a prediction of movement of one or more objects in the vicinity of an unmanned aerial vehicle, according to some aspects;

FIGS. 5A to 5C show an exemplary impact avoidance operation including attitude stabilization, according to some aspects;

FIG. 6 shows an exemplary method for operating an unmanned aerial vehicle, according to some aspects; and

FIG. 7 shows an exemplary method for operating an unmanned aerial vehicle, according to some aspects.

### DESCRIPTION

The following detailed description refers to the accompanying drawings that show, by way of illustration, specific details and aspects in which the disclosure may be practiced.

One or more aspects are described in sufficient detail to enable those skilled in the art to practice the disclosure. Other aspects may be utilized and structural, logical, and/or electrical changes may be made without departing from the scope of the disclosure.

The various aspects of the disclosure are not necessarily mutually exclusive, as some aspects can be combined with one or more other aspects to form new aspects.

Various aspects are described in connection with methods and various aspects are described in connection with devices. However, it may be understood that aspects described in connection with methods may similarly apply to the devices, and vice versa.

The term “exemplary” may be used herein to mean “serving as an example, instance, or illustration”. Any aspect or design described herein as “exemplary” is not necessarily to be construed as preferred or advantageous over other aspects or designs.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g., “a plurality of [objects],” “multiple [objects]”) referring to a quantity of objects expressly refers more than one of the said objects. The terms “group (of),” “set [of],” “collection (of),” “series (of),” “sequence (of),” “grouping (of),” etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The terms “processor” or “controller” as, for example, used herein may be understood as any kind of entity that allows handling data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” detailed herein may be understood to include any suitable type of memory or memory device, e.g., a hard disk drive (HDD), a solid-state drive (SSD), a flash memory, etc.

Differences between software and hardware implemented data handling may blur. A processor, controller, and/or circuit detailed herein may be implemented in software, hardware and/or as hybrid implementation including software and hardware.

The term “system” (e.g., a sensor system, a control system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

The term “position” used with regard to a “position of an unmanned aerial vehicle”, “position of an object”, “position of an obstacle”, and the like, may be used herein to mean a point or region in a two- or three-dimensional space. It is understood that suitable coordinate systems with respective reference points are used to describe positions, vectors, movements, and the like. The term “flight path” used with regard to a “predefined flight path”, a “traveled flight path”, a “remaining flight path”, and the like, may be understood a trajectory in a two-or three-dimensional space. The flight path may include a series (e.g., a time-resolved series) of positions along which the unmanned aerial vehicle has traveled, a respective current position, and/or at least one target position towards which the unmanned aerial vehicle is traveling. The series of positions along which the unmanned aerial vehicle has traveled may define a traveled flight path. The current position and the at least one target position may define a remaining flight path.

The term “map” used with regard to a two- or three-dimensional map may include any suitable way of describing positions of objects in the two- or three-dimensional space.

According to various aspects, a voxel map may be used to describe objects in the three dimensional space based on voxels associated with objects. To prevent collision based on a voxel map, ray-tracing, ray-casting, rasterization, etc., may be applied to the voxel data.

An unmanned aerial vehicle (UAV) is an aircraft that has the capability of autonomous flight. In autonomous flight, a human pilot is not aboard and in control of the unmanned aerial vehicle. The unmanned aerial vehicle may also be denoted as unstaffed, uninhabited or unpiloted aerial vehicle, -aircraft or -aircraft system or drone.

The unmanned aerial vehicle, according to various aspects, may include a support frame that serves as basis for mounting components of the unmanned aerial vehicle, as for example, motors, sensors, mechanic, transmitter, receiver, and any type of control to control the functions of the unmanned aerial vehicle as desired.

The unmanned aerial vehicle, according to various aspects, may include a camera gimbal having an independent two- or three-axes degree of freedom to properly track a target, e.g. a person or point of interest, with a tracking camera independently of an actual flight direction or actual attitude of the unmanned aerial vehicle. In some aspects, a depth camera may be used for tracking, monitoring the vicinity, providing images to a user of the unmanned aerial vehicle, etc. A depth camera may allow associating depth information with an image, e.g., to provide a depth image. This allows, for example, providing an image of the vicinity of the unmanned aerial vehicle including depth information about one or more objects depicted in the image.

As an example, a depth image may include information to indicate a relative distance of objects displayed in the image. This distance information may be, but is not limited to, colors and/or shading to depict a relative distance from a sensor. Positions of the objects may be determined from the depth information. Based on depth images, a three dimensional map may be constructed from the depth information. Said map construction may be achieved using a depth map engine, which may include one or more processors or a non-transitory computer readable medium configured to create a voxel map (or any other suitable map) from the depth information provided by the depth images. According to various aspects, a depth image may be obtained by a stereo camera, e.g., calculated from two or more images having a different perspective.

The unmanned aerial vehicle, according to various aspects, includes at least one sensor for obstacle detection, e.g. only one sensor, two sensors, or more than two sensors. The at least one sensor can be fixedly mounted on the support frame of the unmanned aerial vehicle. Alternatively, the at least one sensor may be fixed to a movable mounting structure so that the at least one sensor may be aligned into a desired direction. The number of sensors for obstacle detection may be reduced to only one sensor that is directed into a heading direction of the unmanned aerial vehicle.

According to various aspects, an unmanned aerial vehicle may have a heading direction. The heading direction may be understood as a reference direction assigned with a straightforward flight direction.

The unmanned aerial vehicle described herein can be in the shape of an airplane (e.g. a fixed wing airplane) or a copter (e.g. multi rotor copter), i.e. a rotorcraft unmanned aerial vehicle, e.g. a quad-rotor unmanned aerial vehicle, a hex-rotor unmanned aerial vehicle, an octo-rotor unmanned aerial vehicle. The unmanned aerial vehicle described herein may include a plurality of rotors (e.g., three, four, five, six, seven, eight, or more than eight rotors), also referred to as propellers. Each of the propeller has one or more propeller blades. The propellers may be fixed pitch propellers.

The unmanned aerial vehicle may be configured to operate with various degrees of autonomy: under remote control by a human operator, or fully or intermittently autonomously, by onboard computers. The unmanned aerial vehicle may be configured to take-off and land autonomously in a take-off and/or a landing mode. Alternatively, the unmanned aerial vehicle may be controlled manually by a radio control (RC) at take-off and/or landing. The unmanned aerial vehicle may be configured to fly autonomously based on a flight path. The flight path may be a predefined flight path, for example, from a starting point or a current position of the unmanned aerial vehicle to a target position, or, the flight path may be variable, e.g., following a target that defines a target position. In some aspects, the unmanned aerial vehicle may switch into a GPS-guided autonomous mode at a safe altitude or save distance. The unmanned aerial vehicle may have one or more fails safe operations modes, e.g., returning to the starting point, landing immediately, etc. In some aspects, the unmanned aerial vehicle may be controlled manually, e.g., by a remote control during flight, e.g. temporarily.

In general, there may be a risk that an unmanned aerial vehicle (also referred to as drone) may collide with one or more other objects (also referred to as obstacles). There may be dangerous situations like an unmanned aerial vehicle potentially hitting an aircraft near an airport, which would cause high damages both in human lives and in material value. There may be also other cases of collisions, e.g. a bird flying into an unmanned aerial vehicle, where besides hurting the animal, the material cost of the unmanned aerial vehicle could be lost in a crash.

Even for advanced pilots, it may be difficult to be aware of the surrounding environment in any case. Therefore, an unmanned aerial vehicle may include one or more aspects of collision detection and avoidance. The collision avoidance may be used in the case that a pilot approaches with the unmanned aerial vehicle an obstacle, as for example, a wall, a tree, etc. Based on information of the surrounding (also referred to as vicinity) of the unmanned aerial vehicle, e.g., measured by one or more sensors, the unmanned aerial vehicle may perform a collision avoidance operation in the case that the pilot continues to steer into the obstacle. For energy conserving reasons, a conventional collision avoidance operation may be carried out without reducing altitude of the unmanned aerial vehicle, illustratively, either to divert to the left or to the right. In some cases, if these options are blocked by an obstacle as well, the unmanned aerial vehicle may change its height, e.g., conventionally trying to fly higher to overfly the obstacle.

In some aspects, a collision avoidance action (also referred to as impact avoidance) may be used in the case that an actively moving obstacle (e.g., a bird, an airplane, etc.) is moving fast towards the unmanned aerial vehicle (instead of the unmanned aerial vehicle slowly flying towards a static obstacle). For fast-moving (e.g., flying) obstacles, a standard collision avoidance actions might not be sufficient to avoid a collision. According to various aspects, a fast-moving obstacle may be any object moving with a velocity greater than 10 m/s, e.g., greater than 20 m/s or greater than 30 m/s. Further, a fast-moving obstacle may be any object moving with a velocity greater than a maximal velocity the unmanned aerial vehicle may achieve.

According to various aspects, an automated drive engine shutdown may be used for a controlled collision avoidance, evading actively fast-moving objects on collision course (also referred to as impact avoidance). This may either prevent the collision at all or at least decreases the damage. In some aspects, the drive engine, e.g., an electric drive, of at least one vehicle drive arrangement may be switched off completely or, alternatively, at least a drive power may be substantially reduced. According to various embodiments, a processor, a controller, a control circuit, or any other suitable electronic device may be used to control the respective drive engine, e.g., an electric drive, of the unmanned aerial vehicle.

Illustratively, an impact avoidance, as described herein, may include stopping one or more propellers of the unmanned aerial vehicle (or at least substantially reducing their rotational velocity) during flight such that the unmanned aerial vehicle rapidly loses altitude, e.g., in a free fall.

According to various aspects, in the case that a moving object approaches the unmanned aerial vehicle with a certain velocity, a controlled flight to the left or right might not allow to prevent a collision, since, for example, the respective acceleration capability of the unmanned aerial vehicle along horizontal directions may be limit. Therefore, an impact avoidance operation may be performed downwards, for example, based on an automated motor shutdown. This may be a quick maneuver since gravity may cause an effective acceleration.

According to various aspects, the unmanned aerial vehicle may have a lateral acceleration capability of less than 10 m/s², e.g., in the range from about 1 m/s² to about 8 m/s², e.g., in the range from about 1 m/s² to about 6 m/s². According to various aspects, the unmanned aerial vehicle may have an acceleration capability for a vertical ascending of less than 10 m/s², e.g., in the range from about 1 m/s² to about 6 m/s², e.g., in the range from about 1 m/s² to about 4 m/s².

As an example, an obstacle approaching the unmanned aerial vehicle with a speed of about 30 m/s may be detected via the one or more sensors of the unmanned aerial vehicle about 1 s before an impact. A typical acceleration of the unmanned aerial vehicle may be about 5 m/s² for a movement left, right, forwards, and/or backwards (i.e. a movement in a horizontal direction) and about 2 m/s² for a movement upwards (also referred to as climbing in height, e.g., in vertical direction). This may allow a movement of the unmanned aerial vehicle of about 2.5 m in 1 s in a horizontal direction and 1 m in 1 s in the upwards direction. In contrast, a gravitational acceleration of about 9.81 m/s² may allow the unmanned aerial vehicle to fall about 5 m in about 1 s.

As an additional safety feature, some of the motors of the unmanned aerial vehicle may be disabled if a collision is inevitable. In some aspects, the electric drive associated with one or more propellers at a side of the unmanned aerial vehicle facing the approaching object may be fully shut off. As an example, the point of impact with the unmanned aerial vehicle may be estimated (e.g., calculated) based on an analysis of the data from a collision detection algorithm and, based on the estimation, the respective propellers may be stopped. This may prevent or reduce a damage of both the propellers and the object that hits the unmanned aerial vehicle.

According to various aspects, an obstacle may be any object that may damage the unmanned aerial vehicle or at least reduce the functionality of the unmanned aerial vehicle in the case of a collision. According to some aspects, one or more sensors of the unmanned aerial vehicle may be configured to deliver any type of information about objects in the vicinity of the unmanned aerial vehicle that may be used for obstacle detection, collision prediction and avoidance, etc., in automated unmanned aerial vehicle tasks.

In the following, an unmanned aerial vehicle is described in more detail. The unmanned aerial vehicle may include at least one collision (impact) avoidance function that is based on reducing the altitude of the unmanned aerial vehicle. In this case, the unmanned aerial vehicle may be controlled in such a way that the gravitational acceleration is utilized for collision avoidance, e.g., such as where a flying object approaches the unmanned aerial vehicle on a collision course. Illustratively, this collision avoidance may be an emergency measure, which may be applied only in pre-defined situations, since movement control of the unmanned aerial vehicle may be partially lost. Therefore, in some aspects, this collision avoidance function relying on reduction of unmanned aerial vehicle altitude may supplement a conventional collision avoidance function used to fly around slow or static obstacles.

According to various aspects, the unmanned aerial vehicle may receive (e.g., determine, sense, etc.) information about its vicinity in order to determine potentially colliding objects. In some aspects, the received information may be used to include the respective obstacles, e.g., at least the potentially colliding objects, in a map. The map may represent the vicinity of the unmanned aerial vehicle and the respective obstacles based on geometric data, point clouds, voxels or other representations. In the following, various configurations of the unmanned aerial vehicle and various functionalities may be described for voxels, a voxel map, and ray tracing. However, alternatively or additionally, other suitable representations may be used as well.

In the following, various configurations and/or functionalities of an unmanned aerial vehicle are described, according to various aspects. In one or more aspects, the unmanned aerial vehicle may include a collision avoidance system (e.g., including one or more sensors, processors, etc.) configured to detect an obstacle approaching the unmanned aerial vehicle on a collision course and to control the unmanned aerial vehicle to reduce altitude to avoid a collision with the detected obstacle. The obstacle approaching the unmanned aerial vehicle may be any type of flying object, e.g., a bird, another drone, an airplane, etc.

Various aspects may be related to the determination of the obstacle information of one or more obstacles in the vicinity of the unmanned aerial vehicle and to generate movement data from the obstacle information. The obstacle information may include, for example, position information of the one or more obstacles in the vicinity of the unmanned aerial vehicle. The obstacle information may include, for example, position information of the one or more obstacles relative to the position of the unmanned aerial vehicle. The movement data may include movement information of the one or more obstacles, e.g., a movement direction, a movement speed, an acceleration, etc. The movement information may be associated with a path of movement of the one or more obstacles. A path of movement may be defined by the positions of the one or more obstacles at various times.

According to various aspects, a map may be used to store position information and/or the movement information in a suitable form of data that allows controlling one or more operations (e.g., impact prediction, reducing altitude, obstacle detection and avoidance, etc.) of the unmanned aerial vehicle based on the map. However, other suitable implementations may be used to allow control of the unmanned aerial vehicle based on at least the movement data.

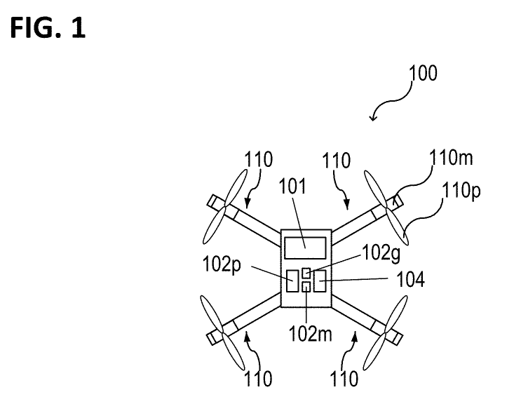

FIG. 1 illustrates an unmanned aerial vehicle 100 in a schematic view, according to various aspects. In one or more aspects, the unmanned aerial vehicle 100 may be configured as described above with reference to the unmanned aerial vehicle 100. The unmanned aerial vehicle 100 may include a plurality of (e.g., three or more than three, e.g., four, six, eight, etc.) vehicle drive arrangements 110. Each of the vehicle drive arrangements 110 may include at least one drive motor 110m and at least one propeller 110p coupled to the at least one drive motor 110m. According to various aspects, the one or more drive motors 110m of the unmanned aerial vehicle 100 may be electric drive motors. Therefore, each of the vehicle drive arrangements 110 may be also referred to as electric drive or electric vehicle drive arrangement.

Further, the unmanned aerial vehicle 100 may include one or more processors 102p configured to control flight or any other operation of the unmanned aerial vehicle 100. One or more of the processors 102p may be part of a flight controller or may implement a flight controller. The one or more processors 102p may be configured, for example, to provide a flight path based at least on a current position of the unmanned aerial vehicle 100 and a target positon for the unmanned aerial vehicle 100. In some aspects, the one or more processors 102p may control the unmanned aerial vehicle 100 based on the map, as described in more detail below. In some aspects, the one or more processors 102p may directly control the drive motors 110m of the unmanned aerial vehicle 100, so that in this case no additional motor controller may be used. Alternatively, the one or more processors 102p may control the drive motors 110m of the unmanned aerial vehicle 100 via one or more additional motor controllers. The motor controllers may control a drive power that may be supplied to the respective motor. The one or more processors 102p may include or may implement any type of controller suitable for controlling the desired functions of the unmanned aerial vehicle 100. The one or more processors 102p may be implemented by any kind of one or more logic circuits.

According to various aspects, the unmanned aerial vehicle 100 may include one or more memories 102m. The one or more memories may be implemented by any kind of one or more electronic storing entities, e.g. one or more volatile memories and/or one or more non-volatile memories. The one or more memories 102m may be used, e.g., in interaction with the one or more processors 102p, to build and/or store the map, according to various aspects.

Further, the unmanned aerial vehicle 100 may include one or more power supplies 104. The one or more power supplies 104 may include any suitable type of power supply, e.g., a directed current (DC) power supply. A DC power supply may include one or more batteries (e.g., one or more rechargeable batteries), etc.

According to various aspects, the unmanned aerial vehicle 100 may include one or more sensors 101. The one or more sensors 101 may be configured to monitor a vicinity of the unmanned aerial vehicle 100. The one or more sensors 101 may be configured to detect obstacles in the vicinity of the unmanned aerial vehicle 100. According to various aspects, the one or more processors may be further configured to modify a predefined flight path of the unmanned aerial vehicle 100 based on detected obstacles to generate a collision free flight path to the target position avoiding obstacles in the vicinity of the unmanned aerial vehicle. According to various aspects, the one or more processors may be further configured to reduce altitude of the unmanned aerial vehicle 100 to avoid a collision during flight, e.g., to prevent a collision with a flying object approaching unmanned aerial vehicle 100 on a collision course. As an example, if the unmanned aerial vehicle 100 and the obstacle may approach each other and the relative bearing remains the same over time, there may be a likelihood of a collision.

The one or more sensors 101 may include, for example, one or more cameras (e.g., a depth camera, a stereo camera, etc.), one or more ultrasonic sensors, one or more radar (radio detection and ranging) sensors, one or more lidar (light detection and ranging) sensors, etc. The one or more sensors 101 may include, for example, any other suitable sensor that allows a detection of an object and the corresponding position of the object. The unmanned aerial vehicle 100 may further include a position detection system 102g. The position detection system 102g may be based, for example, on global positioning system (GPS) or any other available positioning system. Therefore, the one or more processors 102p may be further configured to modify a predefined flight path of the unmanned aerial vehicle 100 based on data obtained from the position detection system 102g. The position detection system 102g may be used, for example, to provide position and/or movement data of the unmanned aerial vehicle 100 itself (including a position, e.g., a direction, a speed, an acceleration, etc., of the unmanned aerial vehicle 100). However, other sensors (e.g., image sensors, a magnetic senor, etc.) may be used to provide position and/or movement data of the unmanned aerial vehicle 100. The position and/or movement data of both the unmanned aerial vehicle 100 and of the one or more obstacles may be used to predict a collision (e.g., to predict an impact of one or more obstacles with the unmanned aerial vehicle).

According to various aspects, the one or more processors 102p may include at least one transceiver configured to provide an uplink transmission and/or downlink reception of radio signals including data, e.g. video or image data and/or commands. The at least one transceiver may include a radio frequency (RF) transmitter and/or a radio frequency (RF) receiver.

The one or more processors 102p may further include an inertial measurement unit (IMU) and/or a compass unit. The inertial measurement unit may allow, for example, a calibration of the unmanned aerial vehicle 100 regarding a predefined plane in a coordinate system, e.g., to determine the roll and pitch angle of the unmanned aerial vehicle 100 with respect to the gravity vector (e.g. from planet earth). Thus, an orientation of the unmanned aerial vehicle 100 in a coordinate system may be determined. The orientation of the unmanned aerial vehicle 100 may be calibrated using the inertial measurement unit before the unmanned aerial vehicle 100 is operated in flight modus. However, any other suitable function for navigation of the unmanned aerial vehicle 100, e.g., for determining a position, a velocity (also referred to as flight velocity), a direction (also referred to as flight direction), etc., may be implemented in the one or more processors 102p and/or in additional components coupled to the one or more processors 102p.

According to various aspects, the one or more processors 102p of the unmanned aerial vehicle 100 may be configured to implement an obstacle avoidance as described in more detail below. To receive, for example, position information and/or movement data about one or more obstacles, the input of a depth image camera and image processing may be used. Further, to store the respective information in the (e.g., internal) map of the unmanned aerial vehicle 100, as described herein, at least one computing resource may be used.

According to various aspects, as described in more detail below, the unmanned aerial vehicle 100 may include one or more sensors 101 configured to receive obstacle information associated with a location of one or more obstacles in a vicinity of the unmanned aerial vehicle; and one or more processors 102p configured to generate movement data associated with a locomotion (also referred to as movement or a change in position relative to the ground) of the one or more obstacles based on the obstacle information, predict an impact of the one or more obstacles with the unmanned aerial vehicle based on the generated movement data, and control the unmanned aerial vehicle to reduce an altitude to avoid the impact.

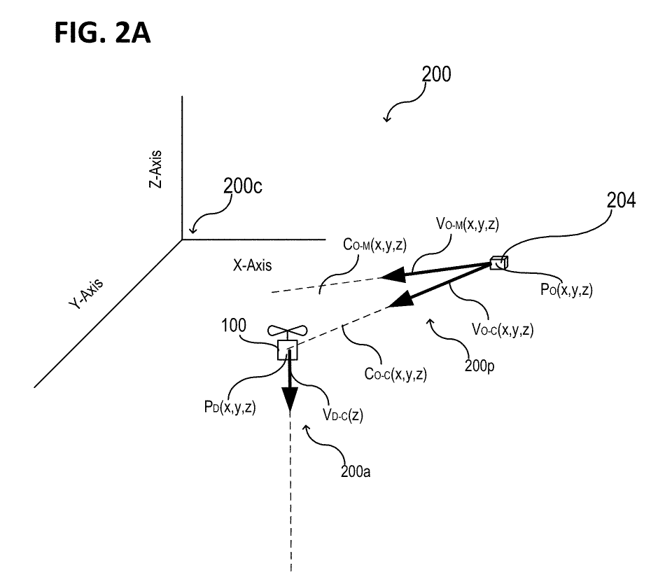

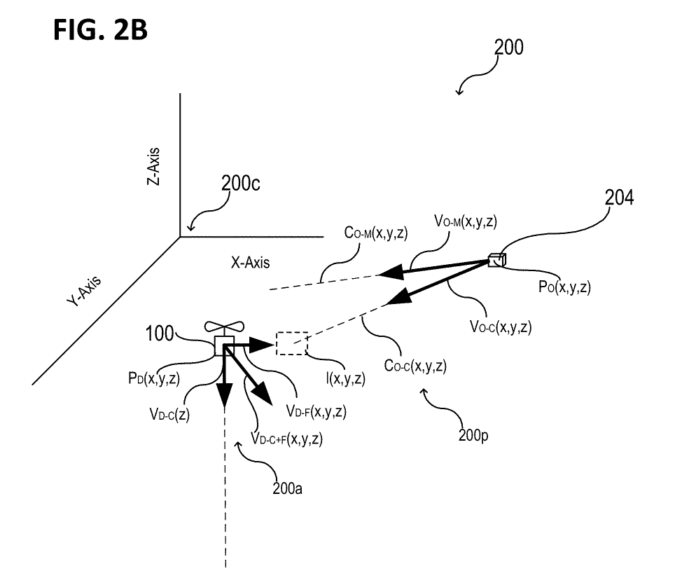

FIG. 2A and FIG. 2B show a collision avoidance operation 200 including predicting an impact 200p of an obstacle 204 with the unmanned aerial vehicle 100 and avoiding 200a the predicted impact 200p, according to various aspects. For illustration, a coordinate system 200c is illustrated in FIG. 2A and FIG. 2B including an x-axis, a y-axis, and a z-axis in an orthogonal arrangement. The z-axis may represent a vertical direction; the x-axis and the y-axis may represent horizontal directions perpendicular to the vertical direction.

According to various aspects, an obstacle position P_{O}(x,y,z) associated with the obstacle 204 may be determined by the one or more sensors of the unmanned aerial vehicle 100 for various times (also referred to as time-resolved). As an example, a camera may be used to determine the current position of the unmanned aerial vehicle 100 in pre-define time intervals, e.g., with a frequency in the range from about 10 Hz to about 60 Hz. Based on a time-resolved series of positions P_{O}(x,y,z) of the obstacle 204, a current movement direction C_{O}(x,y,z) and a current velocity V_{O}(x,y,z) of the obstacle 204 may be determined. The movement direction and the velocity may be determined based on vector calculations using the time-resolved series of positions.

Depending on the current position P_{D}(x,y,z) of the unmanned aerial vehicle 100, a collision of the obstacle 204 with the unmanned aerial vehicle 100 may be predicted. As illustrated in FIG. 2A, the unmanned aerial vehicle 100 may hover at a fixed Position P_{D}(x,y,z) and the obstacle 204 may approach the unmanned aerial vehicle 100. The same case may be considered if the unmanned aerial vehicle 100 travels with a much lower (e.g., 5 times or 10 times lower) velocity than the obstacle 204 so that the movement of the unmanned aerial vehicle 100 itself may be neglectable.

As an example, the obstacle 204 would miss the unmanned aerial vehicle 100, i.e., no impact (i.e. no collision) may be predicted, in the case that the obstacle 204 approaches the position P_{D}(x,y,z) of the unmanned aerial vehicle 100 (from its current position P_{O}(x,y,z)) with a first movement direction C_{O-M}(x,y,z), see FIG. 2A. In this case, no impact avoidance may be carried out, e.g., the altitude of the unmanned aerial vehicle 100 may remain the same. Illustratively, the unmanned aerial vehicle 100 may remain hovering at its position P_{D}(x,y,z).

In another example, the obstacle 204 may hit the unmanned aerial vehicle 100, i.e., an impact (i.e. a collision) may be predicted, in the case that the obstacle 204 approaches the position P_{D}(x,y,z) of the unmanned aerial vehicle 100 (from its current position P_{O}(x,y,z)) with a second movement direction C_{O-C}(x,y,z), see FIG. 2A. In this case, an impact avoidance may be carried out, e.g., the altitude of the unmanned aerial vehicle 100 may be reduced. The unmanned aerial vehicle 100 may accelerate downwards (e.g., along the vertical direction) to reduce altitude. According to various aspects, the velocity V_{D-C}(z) in the vertical direction for reducing altitude may increase over time, since the movement may be a (e.g., uniformly) accelerated motion.

In some aspects, e.g., in the case that the vehicle drive arrangements are switched off completely, the velocity V_{D-C}(z) in the vertical direction during altitude reduction may be substantially defined by the gravitational acceleration, g, increasing with the product of the gravitational acceleration and the time duration, t, (V_{D-C}(z)=g˜t), wherein t is the time duration for which the vehicle drive arrangements are switched off. In the case that the drive power for the vehicle drive arrangements is reduced, the downwards acceleration of the unmanned aerial vehicle 100 may be less than the gravitational acceleration. Illustratively, the downwards acceleration may be reduced due to the respective propulsion that is provided by the vehicle drive arrangements in the opposite direction (e.g., upwards). According to various aspects, the downwards acceleration of the unmanned aerial vehicle 100 may be increased to a value above the gravitational acceleration by providing a propulsion via the vehicle drive arrangements in the same direction (e.g., downwards). As an example, the electric motors of the vehicle drive arrangements may be controlled to reverse the rotational direction of the respective propellers to provide a propulsion that is directed downwards.

According to various aspects, in the case that the unmanned aerial vehicle 100 is hovering at a fixed position over ground, the impact prediction may be carried out based on the movement direction of the obstacle 204 together with the respective positions of the unmanned aerial vehicle 100 and the obstacle 204. In this case, the impact may be likely where the obstacle 204 is illustratively on a collision course with respect to the unmanned aerial vehicle 100.

Further, in the case that the unmanned aerial vehicle 100 may fly over ground with a current velocity, V_{D-F}(x,y,z), the movement of the unmanned aerial vehicle 100 may be considered in the prediction of the impact, as illustrated in FIG. 2B. Illustratively, it may be determined whether the movement V_{O-C}(x,y,z), V_{O-M}(x,y,z) of the obstacle 204 and the movement V_{D-F}(x,y,z) of the unmanned aerial vehicle 100 leads to a collision. The impact at an impact position I(x,y,z) may be predicted, for example, based on the current positions P_{D}(x,y,z), P_{O}(x,y,z) and the velocities V_{O-C}(x,y,z), V_{D-F}(x,y,z), of both the unmanned aerial vehicle 100 and the obstacle 204. As an example, an impact may be predicted based on a predicted or known time-dependency of the velocity of the unmanned aerial vehicle 100 (e.g., based on pre-defined flight path) and a predicted or known time-dependency for the velocity of the obstacle 204. As an example, a predicted or known acceleration of the unmanned aerial vehicle 100 and/or of the obstacle 204 may be considered as well.

As illustrated in FIG. 2B, the velocity V_{D-C}(z) in the vertical direction during altitude reduction may be superimposed with the movement V_{D-F}(x,y,z) of the unmanned aerial vehicle 100 to a resulting velocity V_{D-C+F}(x,y,z).

According to various aspects, the prediction of an impact may be carried out in pre-defined time intervals. As an example, the prediction of an impact may be recalculated each time upon additional information associated with the movement of the obstacle 204 and/or with the movement of the unmanned aerial vehicle 100 is received.

According to various aspects, the prediction of an impact may be carried out (e.g., estimated) by predicting a path of movement of the obstacle 204 starting from a current position of the obstacle and by comparing the predicted path of movement of the obstacle 204 with a remaining flight path of the unmanned aerial vehicle 100 starting from a current position of the unmanned aerial vehicle 100.

According to various aspects, the obstacle 204 (or, in a similar way, a plurality of obstacles) may be detected by the one or more sensors 101 of the unmanned aerial vehicle 100, as described above.

As an example, a map may be generated (e. g., by the one or more processors 102p of the unmanned aerial vehicle 100 using the one or more memories 102m of the unmanned aerial vehicle 100) and one or more objects (in other words obstacles) may be represented in the map 300, as described on more detail below.

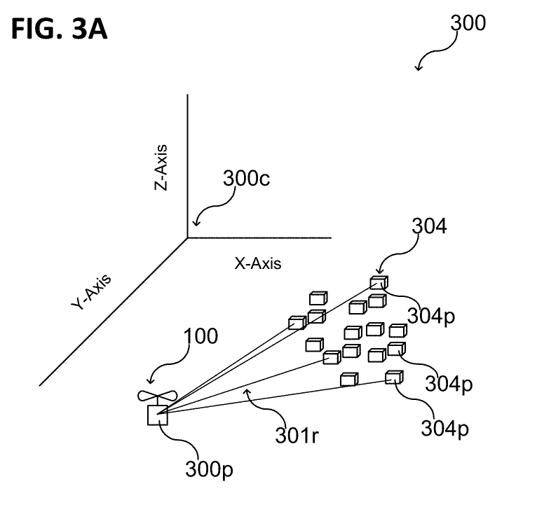

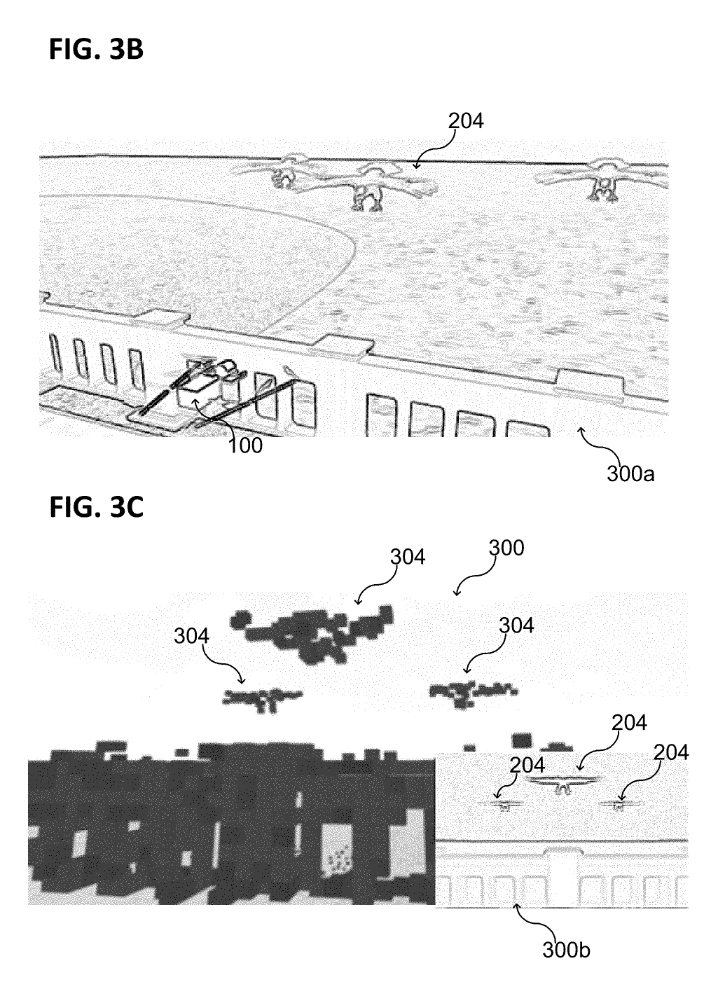

FIG. 3A illustrates a schematic view of a map 300 that is used to control flight of an unmanned aerial vehicle 100, according to various aspects. The unmanned aerial vehicle 100 may be represented in the map 300. As an example, a current position 300p of the unmanned aerial vehicle 100 may be tracked via the map 300 dynamically. Further, one or more objects 304 may be represented in the map 300. As an example, a position 304p of the one or more objects 304 may be determined by the unmanned aerial vehicle 100 and stored in the map 102. The map 300 may be updated dynamically with respect to the one or more objects 304 upon receiving new information associated with the position 304p of the one or more objects 304.

According to various aspects, the map 300 may be a three-dimensional map representing the vicinity (or at least a part of the vicinity) of the unmanned aerial vehicle 100. The map 300 may include a coordinate system 300c. The coordinate system 300c may be, for example, a Cartesian coordinate system including three orthogonal axes (e.g., referred to as X-axis, Y-axis, and Z-axis). However, any other suitable coordinate system 300c may be used.

According to various aspects, the map 300 may be used to represent positions 304p of one or more objects 304 relative to a position 300p of the unmanned aerial vehicle 100. According to various aspects, a computer engine (e.g., a 3D-computer engine) may be used to generate the map 300 and to represent the unmanned aerial vehicle 100 and the one or more objects 304 in the map 300. For visualization, a graphic engine may be used. According to various aspects, dynamics may be included in the map 300, e.g., movement of the one or more objects 304, appearance and disappearance of the one or more objects 304, etc.

According to various aspects, the information on how to build that map 300 may be received from one or more sensors configured to detect any type of objects 304 in a vicinity of the unmanned aerial vehicle 100. As an example, one or more cameras, e.g., one or more RGB cameras, one or more depth cameras, etc., may be used to obtain image data from the vicinity of the unmanned aerial vehicle 100. Based on the obtain image data, the map 300 may be built accordingly. According to various aspects, the map 300 may be built during flight of the unmanned aerial vehicle 100 (e.g., on the fly starting with an empty map 300) using one or more sensors of the unmanned aerial vehicle 100. The information received by the one or more sensors may be stored in one or more memories 102m included in the unmanned aerial vehicle 100. Alternatively or additionally, the map 300 may include one or more predefined objects 304, etc. The predefined objects 304 may be known from a previous flight of the unmanned aerial vehicle 100 or from other information that may be used to build the map 300. According to various aspects, the map 300 of the unmanned aerial vehicle 100 may be correlated with a global map, e.g., via global positioning system (GPS) information, if desired.

According to various aspects, the map 300 may be a voxel map. In this case, the one or more objects 304 and their positions may be represented by one or more voxels in the voxel map. A voxel may include graphic information that defines a three-dimensional volume. Unlike a pixel, which defines a two dimensional space based, for example, on an x-axis and a y-axis, a voxel may have the addition of a z-axis. According to various aspects, the voxels in the voxel map may be configured to carry additional information, such as thermal information, as described in more detail below. According to various aspects, the one or more voxels may be determined from a three-dimensional camera (depth camera) or a combination of image sensors or cameras providing image overlap (e.g., using a 3D-camera). The obtained image data may be processed by a voxel engine to transform the image data into voxels. The voxel engine may be implemented by a computing entity, e.g., including one or more processors, one or more a non-transitory computer readable media, etc. The translation of image data into voxels may be carried out using rasterization, volume ray casting, splattering, or any other volume rendering method. Once translated, the voxels may be stored in the voxel map. Once stored in the voxel map, the flight of the unmanned aerial vehicle 100 may be controlled based on the voxels stored on the voxel map.

According to various aspects, the map 300 may be a dynamic map, e.g., the map 300 may be updated (also referred to as built and/or rebuilt) in a pre-defined time interval, for example, new objects may be added, object may be deleted, position changes of the objects may be monitored, etc. According to various aspects, the map 300 may be updated based on sensor data (e.g., obtained by one or more sensors of the unmanned aerial vehicle 100). Alternatively, the map 300 may be updated based on data transmitted to the unmanned aerial vehicle 100, e.g., via a wireless communication. In the map 300, the position 300p of the unmanned aerial vehicle 100 relative to the position 304p of the one or more objects 304 may change during flight of the unmanned aerial vehicle 100. A reference for a movement of the unmanned aerial vehicle 100 and/or of the one or more objects 304 may be a fixed ground, e.g., defined by GPS information or other suitable information.

According to various aspects, the unmanned aerial vehicle 100 may be configured to check (e.g., during flight) for a collision with one or more objects 304 near the unmanned aerial vehicle 100 based on the map 300. In the case that a voxel map is used, the unmanned aerial vehicle 100 may check for a collision with the one or more objects 304 by ray tracing within the voxel map. However, other implementations of a collision detection may be used.

As illustrated in FIG. 3A, in the map 300, the unmanned aerial vehicle 100 may trace rays 301r against the map (e.g., in any direction, in flight direction, within a sector along the flight direction, etc.) to determine how far objects 304 are away from the unmanned aerial vehicle 100. Further, the direction of the one or more objects 304 relative to the unmanned aerial vehicle 100 may be determined. According to various aspects, a collision avoidance operation may be carried out based on the relative position of the one or more objects 304 with respect to the actual position of the unmanned aerial vehicle 100. Illustratively upon pre-estimating a collision with one or more objects, these one or more objects may be regarded as obstacles, since a collision with a solid object in general may have a high likelihood of harming the unmanned aerial vehicle 100. As an example, the collision avoidance operations may include stopping at a pre-defined safety distance from the detected obstacle, circumflying the detected obstacle with a pre-defined safety distance, increasing distance from the detected obstacle, and/or returning to a pre-defined safety position (e.g., a starting position or return to home position).

According to various aspects, the collision avoidance operation may be modified or extended based on the movement data to avoid an impact of a moving obstacle into the unmanned aerial vehicle 100.

According to various aspects, the map 300 may be a 3D computer graphics environment and ray tracing may be used for collision prediction and avoidance and/or for impact prediction and avoidance.

FIG. 3B illustrates a simulated moving bird attack 300a of birds 204 against the unmanned aerial vehicle 100 (in this case the birds may be moving obstacles). FIG. 3C shows a generated voxel map 300 of the vicinity of the unmanned aerial vehicle 100 including one or more voxel based objects 304 representing the one or more birds 204 from the perspective 300b of the unmanned aerial vehicle 100.

In the following, an exemplary use case is provided for control flight of the unmanned aerial vehicle 100 including obstacle avoidance associated with, for example, static obstacles or slow-moving obstacles and an impact avoidance associated with fast-moving obstacles implemented in the unmanned aerial vehicle 100. Illustratively, static and slow-moving obstacles may be avoided by implementing a conventional obstacle detection and avoidance system that modifies, for example, a predefined flight path via one or more obstacle avoidance operations. However, to avoid impact fast-moving obstacles, the impact avoidance as described herein may be used. A moving obstacle may be classified as slow-moving or fast-moving based on a comparison of the velocity of the obstacle with a reference-velocity or a reference velocity range. The reference-velocity may be defined by the acceleration properties of the unmanned aerial vehicle 100. As an example, if the unmanned aerial vehicle 100 is able to accelerate in a horizontal direction and thereby to avoid a predicted impact, the unmanned aerial vehicle 100 may be controlled accordingly to divert into the horizontal direction. However, if the unmanned aerial vehicle 100 is not able to accelerate rapidly enough in a horizontal direction to avoid a predicted impact, the unmanned aerial vehicle 100 may be controlled to reduce altitude, as described herein, to avoid the predicted impact.

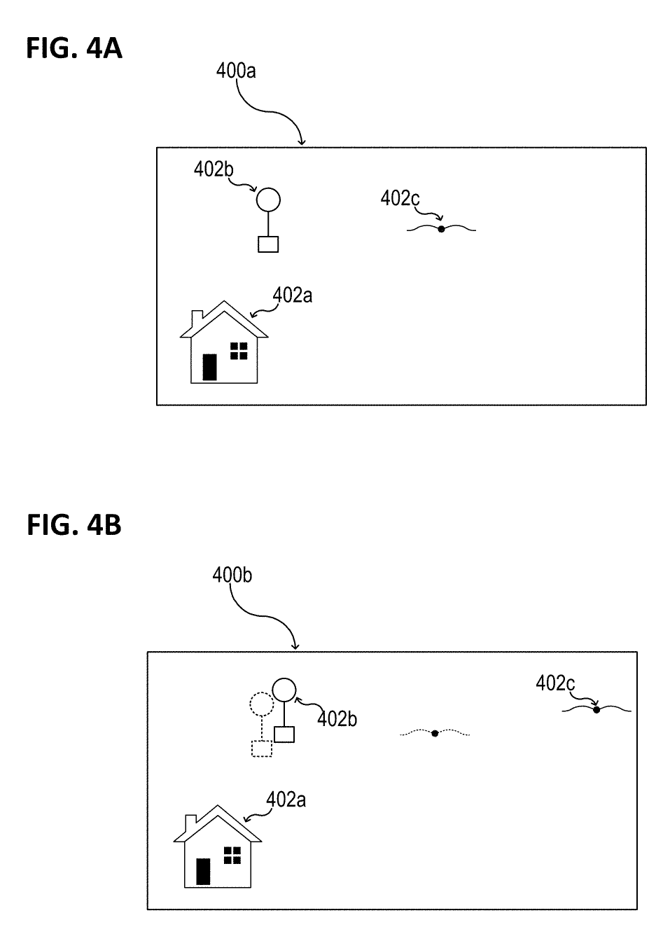

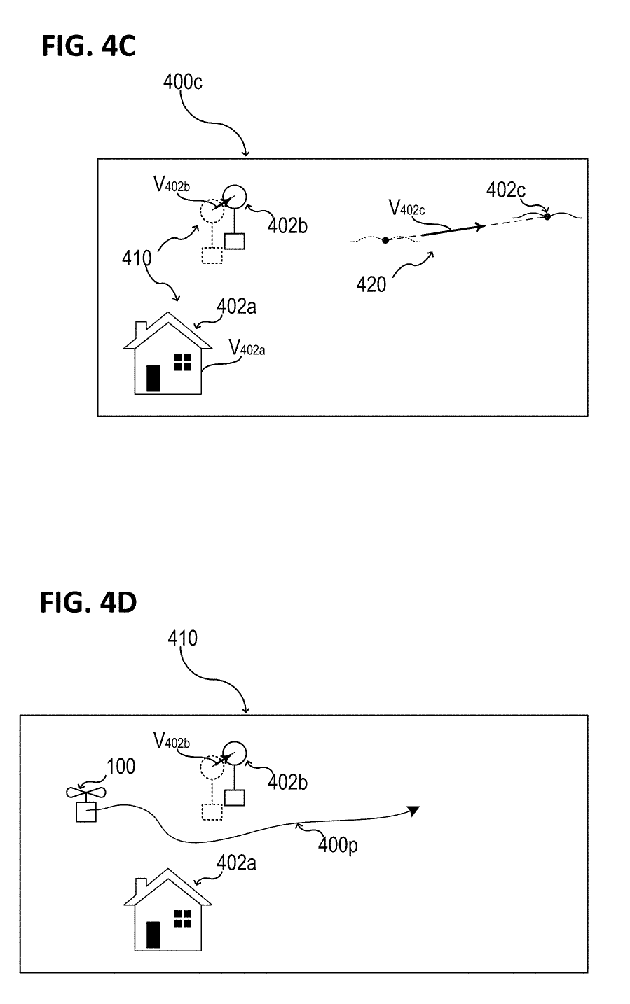

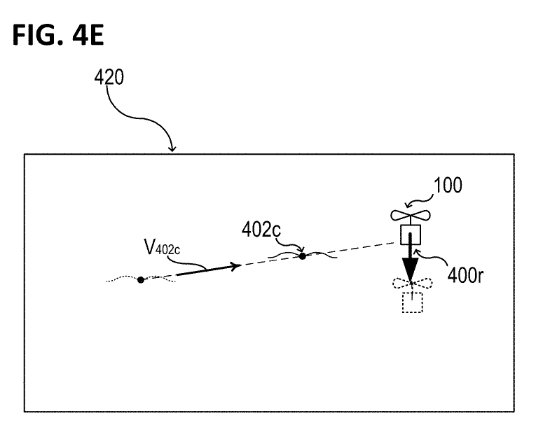

FIG. 4A illustrates exemplarily a first image 400a of one or more obstacles 402a, 402b, 402c that may be detected at a first time, t₁. FIG. 4B illustrates exemplarily a second image 400b of the one or more obstacles 402a, 402b, 402c that may be detected subsequently at a second time, t₂. Based on the images 400a, 400b, the respective position data associated with a position of the one or more obstacles 402a, 402b, 402c may be determined.

According to various aspects, based on the position data and the times (t₁, t₂), time-resolved position data may be generated (e.g., by the one or more processors of the unmanned aerial vehicle 100). According to various aspects, the time-resolved position data may be used to determine, for example, a velocity V₄₀₂ₐ, V_{402b}, V_{402c} for each of the one or more detected obstacles 402a, 402b, 402c, as illustrated in FIG. 4C in a schematic view.

According to various aspects, the one or more detected obstacles 402a, 402b, 402c may be classified based on the time-resolved position data (e.g., based on the respective velocity V₄₀₂ₐ, V_{402b}, V_{402c} determined for each of the one or more detected obstacles 402a, 402b, 402c). The velocity V₄₀₂ₐ of a static obstacle may be zero.

According to various aspects, the one or more detected obstacles 402a, 402b, 402c may be, for example, classified into a first class 410 or a second class 420. As an example, the first class 410 may include static obstacles (e.g., buildings, trees, etc.) and the second class 420 may include moving obstacles (e.g., airplanes, birds, other unmanned aerial vehicles, balls, etc.). In another example, the first class 410 may include static obstacles (e.g., buildings, trees, etc.) and obstacles having a velocity within a predefined velocity range (e.g., a hot air balloon, an aerial lift, etc.). The obstacles having a velocity within a predefined velocity range may be referred to as slow-moving obstacles. According to various aspects, the predefined velocity range may be a range from about 0 m/s to about 30 m/s, e.g., a range from about 0 m/s to about 20 m/s, e.g., a range from about 0 m/s to about 10 m/s. In this case, the second class 420 may include obstacles (e.g., airplanes, birds, other unmanned aerial vehicles, etc.) having a velocity greater than the predefined velocity range. The obstacles having a velocity greater than the predefined velocity range may be referred to as fast-moving obstacles.

FIG. 4D illustrates exemplarily one or more obstacles of the first class 410, e.g., static obstacle (e.g., 402a) and a slow-moving obstacle (e.g., 402b), in the vicinity of the unmanned aerial vehicle 100. According to various aspects, a collision avoidance operation may be carried out. The unmanned aerial vehicle 100 may be controlled in this case to circumfly the one or more obstacles of the first class 410 using any suitable flight path 400p that avoids a collision. Alternatively, the unmanned aerial vehicle 100 may stop and hover at a save position to avoid a collision or any other suitable collision avoidance operation may be used, e.g., increasing a distance from the detected one or more obstacles of the first class 410, returning to a pre-defined safety position (also referred to as return to home function), etc.

FIG. 4E illustrates exemplarily one or more obstacles of the second class 420, e.g., a fast-moving obstacle (e.g., 402c), in the vicinity of the unmanned aerial vehicle 100. The exemplarily one or more obstacles of the second class 420 may approach the unmanned aerial vehicle 100 on a collision course, as described above. In this case, an impact may be predicted and an impact avoidance operation may be carried out. The unmanned aerial vehicle 100 may be controlled, for example, to reduce altitude 400r and thereby to avoid the predicted impact.

According to various aspects, at least one imaging camera may be used to receive (e.g., sense, detect, etc.) obstacle information (e.g., position information, etc.). The at least one imaging camera may be, for example, a depth camera or a stereo camera (e.g., mounted at the unmanned aerial vehicle 100). A depth camera or a stereo camera may provide position information of the one or more obstacles relative to the position of the respective camera at the time when the image is taken. For transforming position information associated with the one or more obstacles of a depth camera or a stereo camera into a position on the map 300, the current position of the depth camera or the stereo camera itself (e.g., the current position of the unmanned aerial vehicle 100) may be used. Therefore, the map 300 may represent the absolute positions (e.g., the positions over ground) of the obstacles and the unmanned aerial vehicle 100. However, any other sensor or sensor arrangement may be used that is suitable to receive the desired obstacle information.

According to various aspects, to calculate or estimate, for example, a velocity of an obstacle, one or more images of the depth camera or the stereo camera taken at various (pre-defined) times may be superimposed (see FIG. 4B and FIG. 4C).

According to various aspects, the obstacle information (e.g., the position information associated with the one or more obstacles) may be used to build the map 300. Further, the movement data may be stored in the map to generate a dynamic map 300. Illustratively, the detected obstacles and, if this is the case their movement, may be stored in a suitable form (e.g., a voxel objects in a voxel map, etc.) to consider the detected obstacles and, if this is the case their movement, in the flight control of the unmanned aerial vehicle 100.

According to various aspects, a depth camera may be calibrated with their intrinsic and extrinsic camera parameters. Once that is done, depth information may be associated with the one or more obstacles to construct the map 300.

According to various aspects, based on the map 300 that is generated and used to control flight of the unmanned aerial vehicle 100, a prediction for a movement of one or more objects detected in the vicinity of the unmanned aerial vehicle 100 may be carried out.

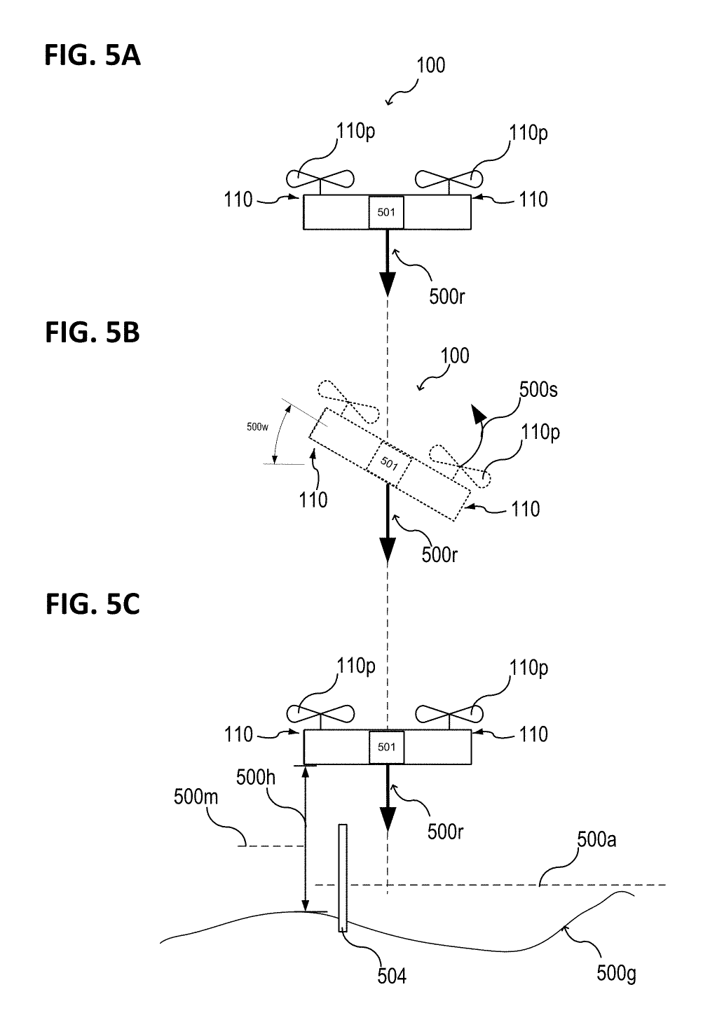

FIG. 5A, FIG. 5B and FIG. 5C illustrate exemplarily the unmanned aerial vehicle 100 during altitude reduction 500r, according to various aspects. According to various aspects, the unmanned aerial vehicle 100 may include an attitude control 501. The attitude control 501 may be implemented, for example, by the one or more processors 102p and the one or more sensors 101 of the unmanned aerial vehicle 100. According to various aspects, the one or more sensors 101 of the unmanned aerial vehicle 100 may include at least one attitude sensor, e.g., at gyroscopic sensor, an inertial measurement unit (IMU), a horizon sensor, a magnetic field sensor, etc. The attitude control 501 may be configured to control each of the vehicle drive arrangements 110 of the unmanned aerial vehicle 100 to provide a controlled propulsion to control the attitude of the unmanned aerial vehicle 100. Since it may be desired that the unmanned aerial vehicle 100 perform the altitude reduction 500r as fast as possible, e.g., substantially in a free fall motion, the vehicle drive arrangements 110 may be controlled in a pulsed mode to provide as less propulsion as possible while maintaining a desired attitude.

During flight, the unmanned aerial vehicle 100 may have six degrees of freedom (6DoF) of movement. As an example, three degrees of freedom may be associated with a translational movement of the unmanned aerial vehicle 100, e.g., forward/backward (surge), upwards/downwards (heave), left/right (sway), in three perpendicular axes, and another three degrees of freedom may be associated with a rotation of the unmanned aerial vehicle 100 around three perpendicular axes, e.g., yaw (normal axis), pitch (lateral axis), and roll (longitudinal axis). During impact avoidance, the vehicle drive arrangements 110 may be controlled to prevent a rotation 500w of the unmanned aerial vehicle 100, e.g., at least a change of the pitch and the roll may be substantially prevented. As an example, one or more propulsions 500s may be provided via the one or more vehicle drive arrangements 110 to counteract a rotation of the unmanned aerial vehicle 100 (e.g., to counteract at least a change of the pitch and/or of the roll).

To retain control over the attitude of the unmanned aerial vehicle 100, the one or more processors 102p of the unmanned aerial vehicle 100 may be configured to reduce the drive power or to switch off the drive power of the one or more vehicle drive arrangements 110 for a series of predefined time durations. Further, the one or more processors 102p of the unmanned aerial vehicle 100 may be configured to control the one or more vehicle drive arrangements 110 during and/or between the predefined time durations to stabilize the attitude of the unmanned aerial vehicle 100.

According to some aspects, a propulsion directed upwards may be provided via one or more of the propellers 110p of the respective vehicle drive arrangements 110 to control the attitude of the unmanned aerial vehicle 100. According to some aspects, a rotational direction of at least one of the propellers 110p may be reversed to control the attitude of the unmanned aerial vehicle 100 via a propulsion that is directed downwards.

Further, a current altitude of the unmanned aerial vehicle 100 may not allow an altitude reduction for impact avoidance without colliding with the ground 500g. Further, an obstacle (e.g., a tree, a chimney, etc.) may be located below the unmanned aerial vehicle 100 that may not allow an altitude reduction for impact avoidance without colliding with this obstacle. Therefore, according to various aspects, a ground collision and/or an obstacle collision due to the impact avoidance operation may be prevented, e.g., by suspending the impact avoidance operation.

As an example, the one or more processors 102p of the unmanned aerial vehicle 100 may be further configured to suspend the reduction of the altitude in the case that a distance to ground 500h of the unmanned aerial vehicle is at or below a predefined safety distance 500m. Illustratively, in this case, a current altitude of the unmanned aerial vehicle 100 may be at or may fall below a predefined safety altitude 500a. According to various aspects, the distance to ground 500h may be determined via a distance measurement implemented via the one or more distance sensors and the one or more processors 102p of the unmanned aerial vehicle 100. According to various aspects, a distance to ground 500h may represent a current altitude of the unmanned aerial vehicle 100 over ground. The predefined safety distance may associated with a predefined safety altitude 500a of the unmanned aerial vehicle 100 over ground, see, for example, FIG. 5C.

According to various embodiments, the one or more sensors 101 of the unmanned aerial vehicle 100 may be further configured to detect a presence of an obstacle 504 located below the unmanned aerial vehicle 100. The one or more processors 102p of the unmanned aerial vehicle 100 may be further configured to suspend the reduction of the altitude in the case that an obstacle is detected below the unmanned aerial vehicle 100.

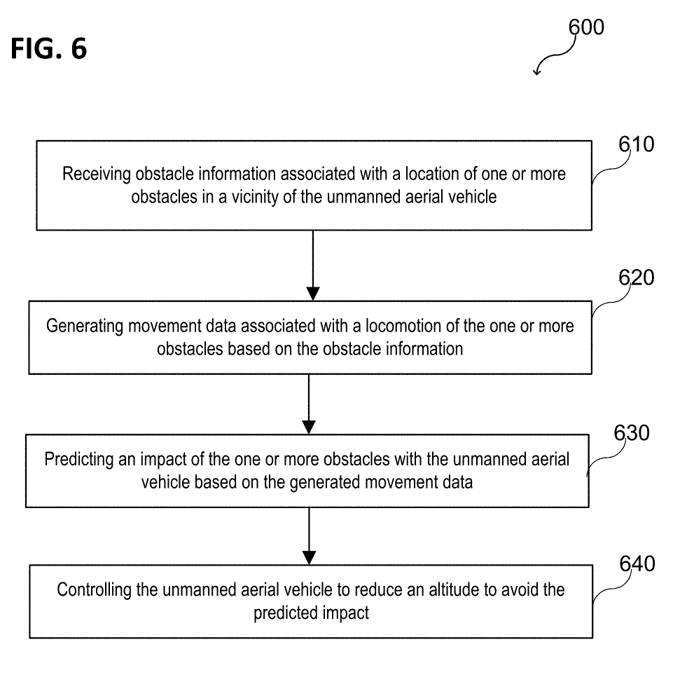

FIG. 6 illustrates a schematic flow diagram of a method 600 for operating an unmanned aerial vehicle (e.g., the unmanned aerial vehicle 100, as described herein), according various aspects. The method 600 may include: in 610, receiving obstacle information associated with a location of one or more obstacles in a vicinity of the unmanned aerial vehicle; in 620, generating movement data associated with a locomotion of the one or more obstacles based on the obstacle information; 630, predicting an impact of the one or more obstacles with the unmanned aerial vehicle based on the generated movement data; and, in 640, controlling the unmanned aerial vehicle to reduce an altitude to avoid the predicted impact.

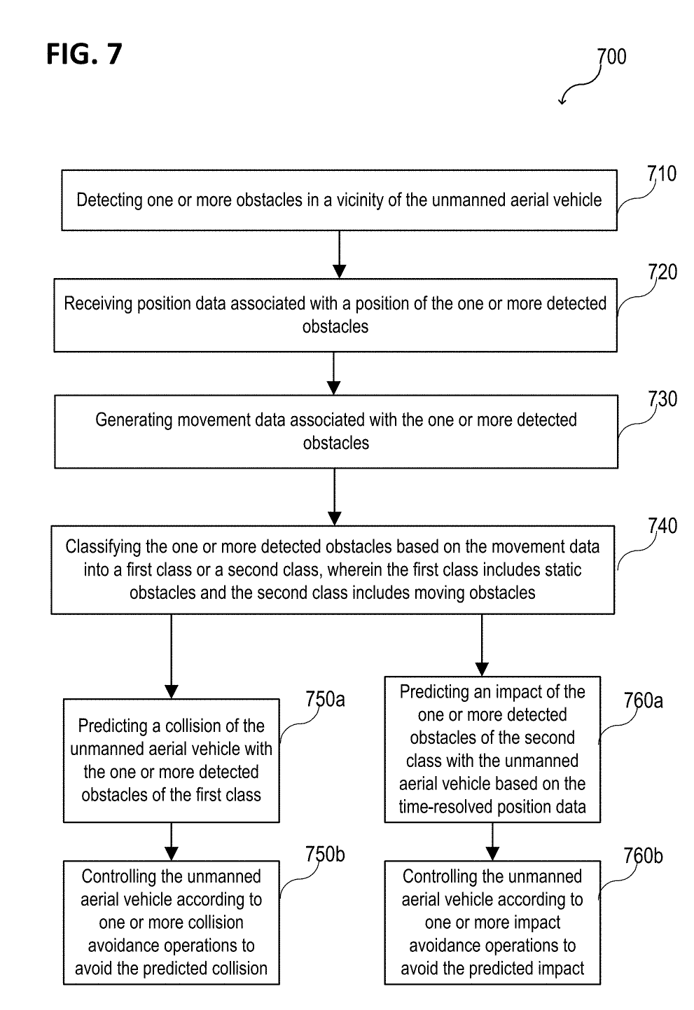

FIG. 7 illustrates a schematic flow diagram of a method 700 for operating an unmanned aerial vehicle (e.g., the unmanned aerial vehicle 100, as described herein), according various aspects. The method 700 may include: in 710, detecting one or more obstacles in a vicinity of the unmanned aerial vehicle; in 720, receiving position data associated with a position of the one or more detected obstacles; in 730, generating movement data associated with the one or more detected obstacles; in 740, classifying the one or more detected obstacles based on the movement data into a first class or a second class, wherein the first class includes static obstacles and the second class includes moving obstacles; in 750a, 750b, predicting a collision of the unmanned aerial vehicle with the one or more detected obstacles of the first class and controlling the unmanned aerial vehicle according to one or more collision avoidance operations to avoid the predicted collision, and, in 760a, 760b, predicting an impact of the one or more detected obstacles of the second class with the unmanned aerial vehicle based on the time-resolved position data and controlling the unmanned aerial vehicle according to one or more impact avoidance operations to avoid the predicted impact.

The term “impact avoidance” is used herein to describe at least the scenario wherein a hovering (also referred to as static) unmanned aerial vehicle avoids a physical contact with an approaching (i.e., moving) obstacle. The term “collision avoidance” is used herein to describe at least the scenario wherein a moving unmanned aerial vehicle approaches a static obstacle and avoids a physical contact with the static obstacle. Where both the unmanned aerial vehicle and the object are in motion and traveling on courses likely to result in a physical contact, the situation may be described as at least one of impact avoidance or collision avoidance, depending on the relative velocities of the unmanned aerial vehicle and the obstacle and/or an ability of the UAV to circumfly the moving obstacle.

According to various aspects, an impact may be predicted based on an estimation of the collision point or collision course, wherein the collision point or collision course may be estimated based on positions and velocities of the obstacle and the unmanned aerial vehicle. However, alternatively or additionally, the collision point or collision course may be estimated based on the acceleration and the jerk (referred to as jolt, surge, or lurch) of the obstacle and/or the unmanned aerial vehicle. The jerk may be represented by a vector associated with the rate of change of acceleration [distance/time³], with the unit of, for example, m/s³ or of standard gravity per second (g/s). As an example, considering the jerk of an obstacle and/or the unmanned aerial vehicle in addition to the positions and velocities may allow for a more precise prediction of a potential impact.

In the following, various examples are provided with reference to the aspects described herein.

Example 1 is an unmanned aerial vehicle, including: one or more sensors configured to receive obstacle information associated with a location of one or more obstacles in a vicinity of the unmanned aerial vehicle; and one or more processors configured to generate movement data associated with a locomotion of the one or more obstacles based on the obstacle information, predict an impact of the one or more obstacles with the unmanned aerial vehicle based on the generated movement data, and control the unmanned aerial vehicle to reduce an altitude to avoid the predicted impact.

In Example 2, the unmanned aerial vehicle of example 1 may further include that the obstacle information represents a time-resolved series of positions of the one or more obstacles.

In Example 3, the unmanned aerial vehicle of example 1 or 2 may further include that at least one of the one or more sensors is a camera providing the obstacle information.

In Example 4, the unmanned aerial vehicle of example 3 may further include that the camera is a depth camera or a stereo camera.

In Example 5, the unmanned aerial vehicle of any one of examples 1 to 4 may further include that the one or more processors are configured to predict the impact based on a comparison of the movement data and corresponding position data representing a current position of the unmanned aerial vehicle. Further, the one or more processors are configured to predict the impact based on the movement data and corresponding position data representing a current position of the unmanned aerial vehicle.

In Example 6, the unmanned aerial vehicle of any one of examples 1 to 5 may further include that the one or more processors are further configured to predict a path of movement of the one or more obstacles based on the movement data.

In Example 7, the unmanned aerial vehicle of example 6 may further include that the one or more processors are configured to predict the impact based on the predicted path of movement of the one or more obstacles and a predefined flight path of the unmanned aerial vehicle.

In Example 8, the unmanned aerial vehicle of any one of examples 1 to 7 may further include one or more vehicle drive arrangements, wherein the one or more processors are configured to reduce the altitude by controlling the one or more vehicle drive arrangements.

In Example 9, the unmanned aerial vehicle of example 8 may further include that the one or more processors are configured to reduce a drive power provided to the one or more vehicle drive arrangements to reduce the altitude.

In Example 10, the unmanned aerial vehicle of example 9 may further include that the one or more processors are configured to reduce the drive power to a predefined power value.

In Example 11, the unmanned aerial vehicle of example 10 may further include that the predefined power value is in the range from 0% to 10% of a maximum drive power.

In Example 12, the unmanned aerial vehicle of any one of examples 9 to 11 may further include that the one or more processors are configured to reduce the drive power for a predefined time duration.

In Example 13, the unmanned aerial vehicle of example 12 may further include that the predefined time duration is greater than 0.5 s.

In Example 14, the unmanned aerial vehicle of any one of examples 9 to 11 may further include that the one or more processors are configured to reduce the drive power for a series of predefined time durations.

In Example 15, the unmanned aerial vehicle of example 14 may further include that the predefined time duration ranges from 0.5 s to 2 s.

In Example 16, the unmanned aerial vehicle of example 14 or 15 may further include that the one or more processors are further configured to control the one or more drive arrangements at least one of during the predefined time durations or between the predefined time durations to stabilize an attitude of the unmanned aerial vehicle.

In Example 17, the unmanned aerial vehicle of example 8 may further include that the one or more processors are configured to switch off a drive power for the one or more vehicle drive arrangements to reduce the altitude.

In Example 18, the unmanned aerial vehicle of example 17 may further include that the one or more processors are configured to switch off the drive power for a predefined time duration.

In Example 19, the unmanned aerial vehicle of example 18 may further include that the predefined time duration is greater than 0.5 s.

In Example 20, the unmanned aerial vehicle of example 17 may further include that the one or more processors are configured to switch off the drive power for a series of predefined time durations.

In Example 21, the unmanned aerial vehicle of example 20 may further include that the predefined time durations range from 0.5 s to 2 s.

In Example 22, the unmanned aerial vehicle of example 20 or 21 may further include that the one or more processors are further configured to control the one or more driving arrangements between the predefined time durations to stabilize an attitude of the unmanned aerial vehicle.

In Example 23, the unmanned aerial vehicle of any one of examples 1 to 22 may further include that the one or more processors are further configured to suspend the reduction of the altitude in the case that a distance of the unmanned aerial vehicle to ground is at or below a predefined safety distance or a current altitude of the unmanned aerial vehicle is at or below a predefined safety altitude.

In Example 24, the unmanned aerial vehicle of any one of examples 1 to 23 may further include that the one or more sensors are configured to detect an obstacle below the unmanned aerial vehicle; and that the one or more processors are further configured to suspend the reduction of the altitude based on the obstacle detected below the unmanned aerial vehicle.

In Example 25, the unmanned aerial vehicle of any one of examples 1 to 24 may further include that the one or more sensors are configured to monitor the vicinity of the unmanned aerial vehicle in predefined time intervals.

In Example 26, the unmanned aerial vehicle of any one of examples 1 to 25 may further include that the one or more processors are configured to generate a map representing the vicinity of the unmanned aerial vehicle, and to generate one or more map elements based on the obstacle information, the one or more map elements representing the one or more obstacles.

In Example 27, the unmanned aerial vehicle of example 26 may further include that the map is a three-dimensional map representing a region of flight of the unmanned aerial vehicle.

In Example 28, the unmanned aerial vehicle of example 26 or 27 may further include that the one or more processors are configured to generate the movement data based on the map elements and to predict the impact based on the map elements.

In Example 29, the unmanned aerial vehicle of example 8 may further include that the one or more processors are configured to control (e.g.; to instruct or to initiate) a reversal of a propulsion direction of the one or more vehicle drive arrangements to reduce the altitude.

In Example 30, the unmanned aerial vehicle of example 29 may further include that each of the one or more vehicle drive arrangements includes at least one propeller and that the one or more processors are configured to control (e.g.; to instruct or to initiate) reversal of a rotational direction of the at least one propeller to reverse the propulsion direction.

Example 31 is an unmanned aerial vehicle, including: one or more sensors configured to detect one or more obstacles in a vicinity of the unmanned aerial vehicle, and to receive position data associated with a position of the one or more detected obstacles; and one or more processors configured to generate movement data associated with the one or more detected obstacles, classify the one or more detected obstacles based on the movement data into a first class or a second class, wherein the first class includes static obstacles and the second class includes moving obstacles, predict a collision of the unmanned aerial vehicle with the one or more detected obstacles of the first class and control the unmanned aerial vehicle according to one or more collision avoidance operations to avoid the predicted collision, and predict an impact of the one or more detected obstacles of the second class with the unmanned aerial vehicle based on the time-resolved position data and control the unmanned aerial vehicle according to one or more impact avoidance operations to avoid the predicted impact.

In Example 32, the unmanned aerial vehicle of example 31 may further include that the one or more impact avoidance operations include reducing an altitude of the unmanned aerial vehicle.

In Example 33, the unmanned aerial vehicle of example 31 may further include that the one or more impact avoidance operations include at least one of the following operations: reducing a drive power provided to one or more vehicle drive arrangements of the unmanned aerial vehicle to reduce the altitude; switching off a drive power provided to one or more vehicle drive arrangements of the unmanned aerial vehicle to reduce the altitude; reducing a propulsion of one or more vehicle drive arrangements of the unmanned aerial vehicle to reduce the altitude; or reversing a propulsion direction of one or more vehicle drive arrangements of the unmanned aerial vehicle to reduce the altitude.

In Example 34, the unmanned aerial vehicle of any one of examples 31 to 33 may further include that the one or more collision avoidance operations include at least one of the following operations: stopping at a pre-defined safety distance from the one or more detected obstacles of the first class; circumflying the one or more detected obstacles of the first class with a pre-defined safety distance; increasing a distance from the one or more detected obstacles of the first class; or returning to a pre-defined safety position.

Example 35 is an unmanned aerial vehicle, including: one or more memories including time-resolved position data associated with one or more detected moving obstacles in a vicinity of the unmanned aerial vehicle; and one or more processors configured to predict an impact of the one or more moving obstacles with the unmanned aerial vehicle based on the time-resolved position information, and control the unmanned aerial vehicle to reduce an altitude to avoid the predicted impact.

In Example 36, the unmanned aerial vehicle of example 35 may further include: one or more sensors configured to generate the time-resolved position information.

In Example 37, the unmanned aerial vehicle of example 35 or 36 may further include: one or more receivers configured to receive the time-resolved position information and to provide the time-resolved position information to the one or more memories.

Example 38 is a method for operating an unmanned aerial vehicle, the method including: receiving obstacle information associated with a location of one or more obstacles in a vicinity of the unmanned aerial vehicle; generating movement data associated with a locomotion of the one or more obstacles based on the obstacle information; predicting an impact of the one or more obstacles with the unmanned aerial vehicle based on the generated movement data; and controlling the unmanned aerial vehicle to reduce an altitude to avoid the predicted impact.

In Example 39, the method of example 38 may further include: classifying the one or more obstacles based on the movement data into a first class or a second class, wherein the first class includes static obstacles and the second class includes moving obstacles; and controlling the unmanned aerial vehicle to reduce the altitude to avoid an impact with one or more obstacles of the second class.

In Example 40, the method of example 38 may further include: classifying the one or more obstacles based on the movement data into a first class or a second class, wherein the first class includes static obstacles and obstacles having a velocity within a predefined velocity range and the second class including obstacles having a velocity greater than the predefined velocity range; and controlling the unmanned aerial vehicle to reduce the altitude for one or more obstacles of the second class.

In Example 41, the method of example 39 or 40 may further include: generating a collision-free flight path from a current position of the unmanned aerial vehicle to a target positon, the target position being selected to avoid a collision with at least the one or more obstacles of the first class.

In Example 42, the method of example 41 may further include that avoiding the collision with at least the one or more obstacles of the first class is performed according to one or more collision avoidance operations, the one or more collision avoidance operations including at least one of the following operations: stopping at a pre-defined safety distance from the one or more obstacles of the first class, circumflying the one or more obstacles of the first class with a pre-defined safety distance, increasing a distance from the one or more obstacles of the first class, returning to a pre-defined safety position.

Example 43 is a method for operating an unmanned aerial vehicle, the method including: detecting one or more obstacles in a vicinity of the unmanned aerial vehicle; receiving position data associated with a position of the one or more detected obstacles; generating movement data associated with the one or more detected obstacles; classifying the one or more detected obstacles based on the movement data into a first class or a second class, wherein the first class includes static obstacles and the second class includes moving obstacles; predicting a collision of the unmanned aerial vehicle with the one or more detected obstacles of the first class and controlling the unmanned aerial vehicle according to one or more collision avoidance operations to avoid the predicted collision, and predicting an impact of the one or more detected obstacles of the second class with the unmanned aerial vehicle based on the time-resolved position data and controlling the unmanned aerial vehicle according to one or more impact avoidance operations to avoid the predicted impact.

In Example 44, the method of example 43 may further include that the one or more impact avoidance operations include reducing an altitude of the unmanned aerial vehicle.

In Example 45, the method of example 43 may further include that the one or more impact avoidance operations include at least one of the following operations: reducing a drive power provided to one or more vehicle drive arrangements of the unmanned aerial vehicle to reduce the altitude; switching off a drive power provided to one or more vehicle drive arrangements of the unmanned aerial vehicle to reduce the altitude; reducing a propulsion of one or more vehicle drive arrangements of the unmanned aerial vehicle to reduce the altitude; reversing a propulsion direction of one or more vehicle drive arrangements of the unmanned aerial vehicle to reduce the altitude.

In Example 46, the method of any one of examples 43 to 45 may further include that the one or more collision avoidance operations include at least one of the following operations: stopping at a pre-defined safety distance from the one or more detected obstacles of the first class, circumflying the one or more detected obstacles of the first class with a pre-defined safety distance, increasing a distance from the one or more detected obstacles of the first class, returning to a pre-defined safety position.

Example 47 is an unmanned aerial vehicle, including: one or more sensors configured to receive obstacle information associated with a location of one or more obstacles in a vicinity of the unmanned aerial vehicle; one or more vehicle drive arrangements, wherein each of the one or more vehicle drive arrangements includes at least one propeller; and one or more processors configured to generate movement data associated with a locomotion of the one or more obstacles based on the obstacle information, predict an impact of the one or more obstacles with the unmanned aerial vehicle based on the generated movement data, and to control (e.g.; to instruct or to initiate) a reduction of a rotational velocity of the at least one propeller of the one or more vehicle drive arrangements to reduce an altitude to avoid the predicted impact.

Example 48 is an unmanned aerial vehicle, including: one or more sensors configured to receive obstacle information associated with a location of one or more obstacles in a vicinity of the unmanned aerial vehicle; one or more vehicle drive arrangements, wherein each of the one or more vehicle drive arrangements includes at least one propeller; and one or more processors configured to generate movement data associated with a locomotion of the one or more obstacles based on the obstacle information, predict an impact of the one or more obstacles with the unmanned aerial vehicle based on the generated movement data, and to control (e.g.; to instruct or to initiate) a stopping of the at least one propeller of the one or more vehicle drive arrangements to reduce an altitude to avoid the predicted impact.

As another example, the unmanned aerial vehicle of example 8 may include that each of the one or more vehicle drive arrangements includes at least one propeller and that the one or more processors are configured to control a reduction of a rotational velocity of the at least one propeller to reduce the altitude.

As another example, the unmanned aerial vehicle of example 8 may include that each of the one or more vehicle drive arrangements includes at least one propeller and that the one or more processors are configured to control a stopping of the at least one propeller to reduce the altitude.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. An unmanned aerial vehicle, comprising:
one or more sensors configured to receive obstacle information associated with a location of one or more obstacles in a vicinity of the unmanned aerial vehicle; and
one or more processors configured to
generate movement data associated with a locomotion of the one or more obstacles based on the obstacle information,
predict an impact of the one or more obstacles with the unmanned aerial vehicle based on the generated movement data, and
control the unmanned aerial vehicle to reduce an altitude to avoid the predicted impact.

2. The unmanned aerial vehicle of claim 1,
wherein the one or more processors are configured to predict the impact based on the movement data and corresponding position data representing a current position of the unmanned aerial vehicle.

3. The unmanned aerial vehicle of claim 1,
wherein the one or more processors are further configured to
predict a path of movement of the one or more obstacles based on the movement data, and
predict the impact based on the predicted path of movement of the one or more obstacles and a predefined flight path of the unmanned aerial vehicle.

4. The unmanned aerial vehicle of claim 1, further comprising:
one or more vehicle drive arrangements,
wherein the one or more processors are configured to reduce the altitude by controlling the one or more vehicle drive arrangements.

5. The unmanned aerial vehicle of claim 4,
wherein the one or more processors are configured to reduce a drive power provided to the one or more vehicle drive arrangements to reduce the altitude.

6. The unmanned aerial vehicle of claim 4,
wherein each of the one or more vehicle drive arrangements includes at least one propeller and wherein the one or more processors are configured to control a reduction of a rotational velocity of the at least one propeller to reduce the altitude.

7. The unmanned aerial vehicle of claim 5,
wherein the one or more processors are configured to reduce the drive power for a series of predefined time durations.

8. The unmanned aerial vehicle of claim 7,
wherein the one or more processors are further configured to control the one or more drive arrangements at least one of during the predefined time durations or between the predefined time durations to stabilize an attitude of the unmanned aerial vehicle.

9. The unmanned aerial vehicle of claim 4,
wherein the one or more processors are configured to switch off a drive power for the one or more vehicle drive arrangements to reduce the altitude.

10. The unmanned aerial vehicle of claim 4,
wherein each of the one or more vehicle drive arrangements includes at least one propeller and wherein the one or more processors are configured to control a stopping of the at least one propeller to reduce the altitude.

11. The unmanned aerial vehicle of claim 9,
wherein the one or more processors are configured to switch off the drive power for a series of predefined time durations.

12. The unmanned aerial vehicle of claim 11,
wherein the one or more processors are further configured to control the one or more driving arrangements between the predefined time durations to stabilize an attitude of the unmanned aerial vehicle.

13. The unmanned aerial vehicle of claim 1,
wherein the one or more processors are further configured to suspend the reduction of the altitude in the case that a distance of the unmanned aerial vehicle to ground is at or below a predefined safety distance or a current altitude of the unmanned aerial vehicle is at or below a predefined safety altitude.

14. The unmanned aerial vehicle of claim 1,
wherein the one or more sensors are configured to detect an obstacle below the unmanned aerial vehicle; and wherein the one or more processors are further configured to suspend the reduction of the altitude based on the obstacle detected below the unmanned aerial vehicle.

15. The unmanned aerial vehicle of claim 4,
wherein the one or more processors are configured to control a reversal of a propulsion direction of the one or more vehicle drive arrangements to reduce the altitude.

16. An unmanned aerial vehicle, comprising:
one or more sensors configured to
detect one or more obstacles in a vicinity of the unmanned aerial vehicle, and
receive position data associated with a position of the one or more detected obstacles; and
one or more processors configured to
generate movement data associated with the one or more detected obstacles,
classify the one or more detected obstacles based on the movement data into a first class or a second class, wherein the first class comprises static obstacles and the second class comprises moving obstacles,
predict a collision of the unmanned aerial vehicle with the one or more detected obstacles of the first class and control the unmanned aerial vehicle according to one or more collision avoidance operations to avoid the predicted collision, and
predict an impact of the one or more detected obstacles of the second class with the unmanned aerial vehicle based on the time-resolved position data and control the unmanned aerial vehicle according to one or more impact avoidance operations to avoid the predicted impact.

17. The unmanned aerial vehicle of claim 16,
wherein the one or more impact avoidance operations comprise reducing an altitude of the unmanned aerial vehicle.

18. The unmanned aerial vehicle of claim 16,
wherein the one or more collision avoidance operations comprise at least one of the following operations:
stopping at a pre-defined safety distance from the one or more detected obstacles of the first class;
circumflying the one or more detected obstacles of the first class with a pre-defined safety distance;
increasing a distance from the one or more detected obstacles of the first class;
returning to a pre-defined safety position.

19. A method for operating an unmanned aerial vehicle, the method comprising:
detecting one or more obstacles in a vicinity of the unmanned aerial vehicle;
receiving position data associated with a position of the one or more detected obstacles;
generating movement data associated with the one or more detected obstacles;
classifying the one or more detected obstacles based on the movement data into a first class or a second class, wherein the first class comprises static obstacles and the second class comprises moving obstacles;
predicting a collision of the unmanned aerial vehicle with the one or more detected obstacles of the first class and controlling the unmanned aerial vehicle according to one or more collision avoidance operations to avoid the predicted collision, and predicting an impact of the one or more detected obstacles of the second class with the unmanned aerial vehicle based on the time-resolved position data and controlling the unmanned aerial vehicle according to one or more impact avoidance operations to avoid the predicted impact.

20. The method of claim 19,
wherein the one or more impact avoidance operations comprise at least one of the following operations:
reducing a drive power provided to one or more vehicle drive arrangements of the unmanned aerial vehicle to reduce the altitude;
switching off a drive power provided to one or more vehicle drive arrangements of the unmanned aerial vehicle to reduce the altitude;
reducing a propulsion of one or more vehicle drive arrangements of the unmanned aerial vehicle to reduce the altitude;
reversing a propulsion direction of one or more vehicle drive arrangements of the unmanned aerial vehicle to reduce the altitude.
